(19) United States
(12) Patent Application Publication
(10) Pub. No.: US 2019/0373000 A1
(43) Pub. Date: Dec. 5, 2019

(54) SYSTEM AND METHOD FOR MONITORING ELECTRONIC CONTENT

(71) Applicant: YouAppi LTD., Raanana (IL)

(72) Inventors: Ofer GARNETT, Herzliya (IL); Asaf DAHAN, Raanana (IL); Guy BASHAN, Netanya (IL); Leon BAM, Tel Aviv (IL)

(21) Appl. No.: 15/993,605

(22) Filed: May 31, 2018

(51) Int. Cl. H04L 29/06; H04L 29/08

(52) U.S. Cl. CPC H04L 63/1416; H04L 67/22

(57) ABSTRACT

The subject matter discloses a system for monitoring electronic content. The system includes an analyzer module adapted for activating an at least one interaction between an end user device and one or more computerized devices, wherein the at least one interaction causing an exchange of network data traffic between the end user device and the one or more computerized devices over a data communication link; and a communication monitor adapted for monitoring the network data traffic; wherein the analyzer module is further adapted for processing the network data traffic and for determining a compliance or incompliance of the network data traffic with a certain criteria.

### TECHNOLOGICAL FIELD

The present invention is generally in the field of monitoring of electronic content, and its distribution to, and behavior on, users' devices.

### BACKGROUND

More and more applications executed by computerized devices having network connectivity e.g., smartphones, tablets and laptops, access electronic content that the user and/or device interacts with. The downloaded electronic content (e.g., movies, advertisements, presentations, webpages, and suchlike) can comprise, inter alia, embedded image data, video data, audio data, text data and/or executable code. Ideally, such downloadable electronic content is inoffensive and dedicated to the cause for which it was designed (e.g., amusement, advertisement, education). However, in many occasions downloadable electronic content is tweaked, or intentionally designed, to inappropriately collect information about the users and/or their devices, to fake certain events/interactions and/or activities, and even for malicious conducts (e.g., malicious 15 advertising, also known as malvertising).

For example, advertisement content may be fraudulency configured to generate invalid/false ‘clicks’ or impressions, and/or invalid network traffic, artificially (e.g., using automated clicking tools, automated traffic sources, robots, or suchlike) to intentionally inflate an advertiser's costs or a publisher's earnings, which may entail serious sanctions on publishers that exhibit high levels of such invalid activity. As another example, in malvertising harmful online advertisements are seeded into legitimate publisher's websites, which can infect computerized devices having software vulnerabilities merely by viewing the advertisement.

Various different tools can be used to identify fraudulent traffic/clicks and generated fake events, but these tools typically come into use after some damage was already done. Some suggested solutions known from the patent literature are briefly described below.

U.S. Pat. No. 7,627,878 suggests monitoring and recording channels of TV, radio or broadcast media by storing and tagging discrete portions of segments of the broadcast signals in a database to automatically verify/audit the timing and placement of advertising on TV, radio or other broadcast media. A controller, or “dispatcher” server, dispatches the files to an analysis server for performing various mathematical comparisons and statistical correlations on the audio and video signals for positively identifying one or more advertisements of interest. A report is generated, providing particulars about the airing times of the advertisement of interest and whether its content exactly matches the content of a reference advertisement used as the basis for the mathematical comparisons and correlations.

US Patent Publication No. 2008/243571 suggests an advertisement auditing system that determines whether advertisements are being presented to or displayed on client devices in an intended fashion. By comparing expected advertising results with actual advertising results on a client device, it is possible to evaluate the accuracy of advertising campaigns and advertisement content delivery. In various embodiments, the client device(s) may be virtualized to improve flexibility and scalability of auditing functions.

US Patent Publication No. 2011/321044 suggests a client hypervisor-based terminal device that includes an advertisement module that provides an advertisement, an advertisement time controlling part that monitors a user time of a user module, and a client hypervisor part which operates the advertisement module based on a result of monitoring by the advertisement time controlling part. Accordingly, an advertisement is provided, satisfying both an advertiser and a user of the terminal device.

### GENERAL DESCRIPTION

The present application provides techniques for monitoring digital content accessible by users' devices over a communication link. Suggested solutions heretofore attempted to audit broadcasted electronic content (also referred to herein as digital content) for verifying that the expected content is indeed being broadcasted and that it is properly presented in the user's devices. However these solutions don't examine the interaction between the accessed content and the users' devices and thus cannot be used to determine if the accessed content is improper and/or harmful.

The present disclosure provides techniques, and systems and methods implementing them, for monitoring electronic content accessible by a user device over a communication link and authenticating the validity, intentions/aims and other properties of the accessed content. Embodiments of the present disclosure are thus configured to examine interactions of the electric content with the user device accessing it, and/or with other computerized devices communicably linked to the user device. Communication traffic conducted over the communication link in response to the access of the electric content and/or responsive to interactions of the electronic content with the user device and/or other communicable computerized devices, can be also examined to verify that the accessed content is not causing inappropriate, invalid and/or harmful, communication traffic.

In this way it is possible to determine if the accessed electronic content is generating false events (e.g., fake click-through and/or install reports) and/or invalid communication traffic over the communication link, and also other properties of accessed content. For example, and without being limiting, the monitored content can be also examined to determine how it is configured to be presented at the end user's device, and/or the type of audience/end users the content is targeted for, and/or the type/model of user device, and/or the operating system (OS), the content is aimed for. Embodiments of the present disclosure are also configured to challenge the accessed content by causing different types of events/interactions therewith (e.g., click-through, mouse hover, and/or accesses of other content), to examine its behavior and determine if invalid traffic and/or event reports are thereby caused. All these tests and examinations of the monitored electronic content are eventually used to conclude if it complies with set forth criteria and/or policy.

Embodiments of the present disclosure can be also used to audit advertisers' affidavits and verify that the advertisements are presented to the end users and interact with their devices according to contracts/agreements between the advertisers and the 25 publishers. Thus, in some embodiments reports/alerts are generated for indicating invalid interactions and/or communication traffics caused by the monitored content, and/or improper presentation thereof in the end user device.

In a broad aspect there is provided a content monitoring system capable of exchanging data over a communication link and comprising at least one end user device configured to access electronic content via the communication link, a traffic monitor configured to listen to communication traffic transferred over the communication link and generate traffic data indicative thereof, and an analyzer unit configured to monitor, and/or initiate, interactions between accessed content and the at least one end user device, process the traffic data and determine inconsistencies therebetween and compliance with predefined criteria/policy.

The analyzer comprises in some embodiments a plurality of test modules, each configured to set/define properties of the at least one end user device and/or its user, such as, but not limited to, the type/model of the device, and/or an OS of the device, and/or software applications to be executed by the device, and/or geographic location of the device, and/or gender and or age of a user of the device, and/or internet service provider (ISP) of the device, and suchlike. The test modules can be configured to cause the at least one end user device to access predefined network locations configured to present digital content, such as publisher's/e-commerce sites or online services, or to participate in network activities (e.g., online games/chats) that present such digital content, inspect network traffic generated in response to the caused access and interactions between the accessed network locations/digital content and the end user device and/or software applications executed by it, and determine inconsistencies therebetween and/or compliance with the predefined criteria/policy.

The test modules can be configured to also inspect a container of the digital content used for conveying the digital content to the end user device. The container (also referred to herein as carrier medium) can be a website or a downloadable software application configured to present the digital content. Optionally, and in some embodiments, the test modules are configured to simulate user's events/actions or interactions between the digital content and/or its container and the end user device and/or software application executed by it, inspect network traffic generated in response to the simulated events/action or interactions and determine consistency there between and compliance thereof with the predefined criteria/policy.

In some possible embodiment the analyzer unit is configured to perform the following tests:
(i) check whether the content is faking events and generating invalid traffic, and/or being malicious or a threat to the user of the device;
(ii) check whether a container of the content is faking events and generating invalid traffic, and/or being malicious or a threat to the user of the device; and/or
(iii) verify that the distributer/publisher of the digital content is correctly matching the context of the conveyed digital content according to the properties of the at least one end user device and/or its user as set/defined by the respective test module (e.g., user's gender and/or age and/or preferences and/or fields of interest, geographic location, OS, and/or running applications, etc.).

In some embodiments the at least one end user device is implemented by a virtual machine. Optionally, and in some embodiments preferably, a plurality of virtual machines are used by the analyzer unit to virtualize a plurality of end user devices. Each virtual machine is implemented according to definitions of one of the plurality of test modules of the analyzer unit, thereby allowing the analyzer unit to monitor a plurality of digital contents, and/or containers of such contents. Alternatively, the analyzer unit can be configured to monitor a single content, and/or its container, with a plurality of virtual machines, each configured to operate with a different set of definitions as provided by the respective test modules. In this way, the plurality of test modules of the analyzer unit can be implemented by executable scripts. One or more processors and memories can be thus used to implement the analyzer unit, store the scripts of the test modules, and run a plurality of virtual machine instances, each being configured by the analyzer to operate with a predefined set of definitions of one of the test modules.

According to some embodiments the system includes an analyzer module. The analyzer module activates interaction between an end user device and one or more computerized devices. In one example the one or more computerized devices may be servers of a content provider or an Ad Network. The interaction causes an exchange of network data traffic between the end user device and the one or more computerized devices over a data communication link. The term interaction refers herein to one or more events that may be generated by activating interaction data from a script or any other command language. Examples for such events are click, mouse movement, hovering, scrolling or interacting with electronic content presented in the end user device. The term presented refers herein to displayed or played. The term electronic content refers herein to text, video, audio and images.

According to some embodiments the analyzer module processes the network data traffic. The processing may include extracting or identifying data items corresponding to the events that are activated by the interaction data. According to some embodiments the data items are sent from the one or more computing device to the end user device and/or vice versa. The analyzer may check if data items corresponding to an event (that is to say: data items that are expected to be in network data traffic as a result of executing an event) exist in the network data traffic. If the data item does not exist in the network data traffic then the analyzer determines that the network data traffic is not compliant; for example, clicking on an advertisement without detecting corresponding HTTP request.

The analyzer may check the existence of data item that are corresponding to events that were not activated by the interaction data. If the data item exists in the network data traffic then the analyzer may determine that the network data traffic is not compliant; for example detecting an HTTP request to an Ad Network and an absence of a corresponding click event. Such a scenario may indicate fraud activity of the content provider.

The term data item refers a network message or a plurality of network messages or a combination thereof. Examples for such a network message are an HTTP get request and HTTP post request.

One aspect of the subject matter disclosed herein relates to a system for monitoring electronic content by a content monitor configured to track behavior of electronic content being accessed by a user's device. The content monitor comprises at least one end user device configured and operable to exchange data with one or more computerized devices over a data communication link and access and interact with electronic content provided in at least one of the computerized devices over the data communication link, a communication monitor configured and operable to monitor network data traffic over the data communication link of the at least one end user device and generate traffic data indicative thereof, and an analyzer module for processing the traffic data to determine whether data exchange associated with the electronic content complies with a certain criteria/policy.

Optionally, and in some embodiments preferably, the analyzer module is configured and operable to identify interactions between the accessed electronic content and the end user device, generate interaction data indicative thereof, and determine compliance thereof with the certain criteria/policy. Additionally or alternatively, the analyzer module identifies interactions between a medium carrier of the accessed electronic content and the end user device, generate interaction data indicative thereof and determine compliance thereof with the certain criteria. The analyzer module can be also used to identify interactions between the accessed electronic content and a computerized device over the data communication link, generate interaction data indicative thereof, and determine compliance thereof with the certain criteria.

The analyzer module is configured in some embodiments to process the traffic data and identify presence or absence of one or more events therein associated with the electronic content, and determine compliance with the certain criteria based thereon. In this way, the analyzer module can identify presence of a click-through event in the traffic data and absence of a corresponding click-event in the interaction data, to thereby determine a fake click-through event. Similarly, the analyzer module can be used to identify presence of an install report in the traffic data, absence of a corresponding install event in the interaction data, and determine fake install reports accordingly.

Optionally, the analyzer can be used to cause at least one interaction between the end user device and at least one of the following: a computerized device communicable over the data communication link; an application operating in the user device; the electronic content; and a carrier medium of the electronic content, generate respective interaction data indicative of the at least one interaction, process the traffic data and determine compliance thereof with the certain criteria. In some embodiments, the at least one end user device is associated with at least one of geographical location, operating system (OS) of the device, internet service provider (ISP) of the device, age and/or gender and/or preferences of a user of the device. These properties are optionally determined to cause provision of electronic content of a certain type or category to the at least one end user device.

The electronic content can comprise at least one advertisement. The content monitor can be thus configured to track publication of the at least one advertisement by at least one publisher in one or more publishing sites and determine whether the publication comply with the certain criteria. Optionally, the at least one end user device is configured to access the one or more publishing sites to cause uploading of data of the at least one advertisement in at least one publishing site being accessed by the at least one end user device.

Optionally, and in some embodiments preferably, the analyzer module is configured and operable to process the traffic data to identify an ISP associated with communication of the electronic content to the at least one end user device and determine whether the ISP complies with the certain criteria/policy. The at least one end user device can be of a certain device type. The analyzer module can be configured to determine whether provision of the advertisement to the device type complies with the certain criteria. For example, and without being limiting, the device type is indicative of at least one of a particular model of an end user device and a particular operating system of an end user device.

In some possible embodiments, the at least one end user device is at least one of an actual end user device and a virtual machine emulation of an end user device associated with a particular device model and operating system. For example, and without being limiting, the at least one end user device is one of: a mobile telephone, a tablet, a personal computer, a laptop, a PDA, a media player, and smart TV. Optionally, the at least one end user device implements at least one of different types of devices and different ISPs and being configured and operable for accessing the publishing site from the different types of devices or different ISPs to thereby determine statistics of provision of the advertisement to the different types of devices or ISPs.

Association with a publishers' data repository storing publisher data indicative of the one or more publishers and the one or more publishing sites can be used to access the publishing sites by the at least one end user device for loading the at least one advertisement. Optionally, the publisher data comprises data indicative of at least one of the following: (i) addresses of one or more publishing sites, and (ii) executable applications, which are executable by the at least one end user device and adapted to interact with the advertisements. The analyzer module can be configured to process each accessed publishing site to determine whether it is configured to present the at least one advertisement.

Whenever it is determined that the publishing site is configured to present the at least one advertisement the publishing site is analyzed by the analyzer to determine parameters of the publication of the advertisement thereby, and the publication parameters are processed by the analyzer to compare them with the certain criteria including publication prerequisites of the advertisement to determine whether the advertisement publication complies with the prerequisites. The parameters and the corresponding publication prerequisites can include one or more of the following: an identity of the publishing site; an indication whether the advertisement being incentivized or not; a loading time of the advertisement from the publishing site; a location of the advertisement on a display generated by the publishing site; and networks associated with the publisher and/or the advertiser. Optionally, the analyzing of the publishing site comprises determining whether the publishing site is configured to generate fake click-through and/or fake install report traffic.

The analyzer module comprises in some embodiments a customizable analysis engine configurable for processing and analyzing different publishing sites to determine the parameters of the advertisement presented therein. Optionally, and in some embodiments preferably, the analyzer comprises a plurality of customizable analysis engines each being configured and operable to operate at least one of the end user devices and associate the at least one end user device with at least one of device type and/or model, an OS of the device, software applications executed by the device, geographic location of the device, gender and/or age and/or preferences of a user of the device, and ISP of the device. Optionally, the customizable analysis engine is a script based engine.

The analyzer module is configured and operable in some embodiments to activate the advertisement upon determining that the publishing site is configured to present the at least one advertisement, and to process the traffic data generated in response to the activation to identify network communication between the end user device and the publisher and thereby identify the publisher of the publication of the advertisement at the publishing site.

The advertisement can include embedded publisher identification data. The analyzer module can be adapted to utilize the embedded publisher identification data to identify the publisher of the publication of the advertisement at the publishing site, to thereby enable to identify the publisher in case a network communication between the end user device and the publisher is indirect via one or more network affiliates. Advertisement publishment data indicative of one or more advertisements to be monitored by the system can be provided in a data repository. The criteria can be indicative of respective publication prerequisites of the advertisements.

Another inventive aspect of the subject matter disclosed herein relates to a method of monitoring electronic content. The method comprises providing at least one end user device configured and operable to exchange data with one or more computerized devices over a data communication link and access and interact with electronic content provided in at least one of the computerized devices over the data communication link, monitoring network data traffic over the data communication link of the at least one end user device and generating traffic data indicative thereof, and determining whether data exchange associated with the electronic content complies with a certain criteria/policy. Optionally, and in some embodiments preferably, the monitoring comprises determining all network entities participating in the network data traffic and identifying network entities not associated with the accessed electronic content.

The method can comprise identifying interactions between the end user device and at least one of the electronic content and a carrier medium of the electronic content, generating interaction data indicative thereof and determining compliance thereof with the certain criteria/policy. Optionally, the method comprises identifying interactions between the accessed electronic content and a computerized device over the data communication link, generating interaction data indicative thereof and determining compliance thereof with the certain criteria/policy.

In some embodiment the method comprise processing the traffic data and identifying presence or absence of one or more events therein associated with the electronic content, and determining compliance with the certain criteria based thereon. The method can comprise causing at least one interaction between the end user device and at least one of the following: a computerized device communicable over the data communication link; an application operating in the user device; the electronic content; and a carrier medium of the electronic content, generating respective interaction data indicative of the at least one interaction, processing the traffic data and determining compliance thereof with the certain criteria.

Optionally, the method comprises associating the at least one end user device with at least one of geographical location, OS of the device, ISP of the device, age and/or gender and/or preferences of a user of the device, determined for causing accessing of electronic content of a certain type or category.

In some embodiment, the electronic content comprises at least one advertisement. The method can comprise tracking publication of the at least one advertisement by at least one publisher in one or more publishing sites and determining whether the publication comply with the certain criteria/policy. Optionally, the method comprises accessing the one or more publishing sites by the at least one end user device for causing uploading of data of the at least one advertisement in at least one publishing site.

The method can comprise processing the traffic data to determine at least one of the following: whether an ISP associated with communication of the electronic content to the at least one end user device complies with the certain criteria; and/or whether provision of the electronic content to the device being associated with a certain device type and/or model and/or OS complies with the certain criteria.

The method comprises in some embodiments determining statistics of provision of the advertisement to different types of devices or ISPs. Publisher data indicative of one or more publishers and one or more publishing sites thereof can be used for accessing at least one advertisement of the publishing sites, processing the accessed publishing site and determining whether it is configured to present the at least one advertisement. If it is determined that the publishing site is configured to present the at least one advertisement, the method can comprise: analyzing the publishing site to determine parameters of the publication of the advertisement thereby; and processing the publication parameters to compare them with the certain criteria including publication prerequisites of to determine whether the advertisement publication complies with the prerequisites.

Optionally, and in some embodiments preferably, the method comprises implementing the at least one end user device by a plurality of virtual machines and using a plurality of corresponding test modules each for operating at least one end user device and associating it with at least one of device type and/or model, an OS of the device, software applications executed by the device, geographic location of the device, gender and/or age and/or preferences of a user of the device, and ISP of the device.

The method can comprise activating the advertisement upon determining that the publishing site is configured to present the at least one advertisement, and processing the traffic data generated in response to the activation to identify network communication between the end user device and the publisher and thereby identify the publisher of the publication of the advertisement at the publishing site. Optionally, the method comprises identifying in the advertisement embedded publisher identification data and using it to identify the publisher of the publication of the advertisement at the publishing site to thereby enable identifying the publisher.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIG. 1 schematically illustrates a content monitoring system according to some possible embodiments;

FIGS. 2A and 2B schematically illustrate a monitoring techniques of some possible embodiments, wherein FIG. 2A is a functional block diagram illustrating an implementation of the content monitor according to some possible embodiments and FIG. 2B demonstrates monitoring of incoming and outgoing communication;

FIG. 3 schematically illustrates advertisements monitoring system according to some possible embodiments; and

FIGS. 4A and 4B are block diagrams schematically illustrating processes for monitoring electronic content according to some possible embodiments.

### DETAILED DESCRIPTION OF EMBODIMENTS

One or more specific embodiments of the present disclosure will be described below with reference to the drawings, which are to be considered in all aspects as illustrative only and not restrictive in any manner. In an effort to provide a concise description of these embodiments, not all features of an actual implementation are described in the specification. This invention may be provided in other specific forms and embodiments without departing from the essential characteristics described herein.

The present disclosure provides techniques, and systems and methods implementations thereof, for monitoring the behavior of, and interaction with, electronic content accessible (e.g., through the Internet) by a user device via a communication link (e.g., over wireless RF channels, such as, WLAN/WiFi, cellular or satellite communication, and/or over wired channels such as conducted over landline/cables infrastructures using DSL, or suchlike).

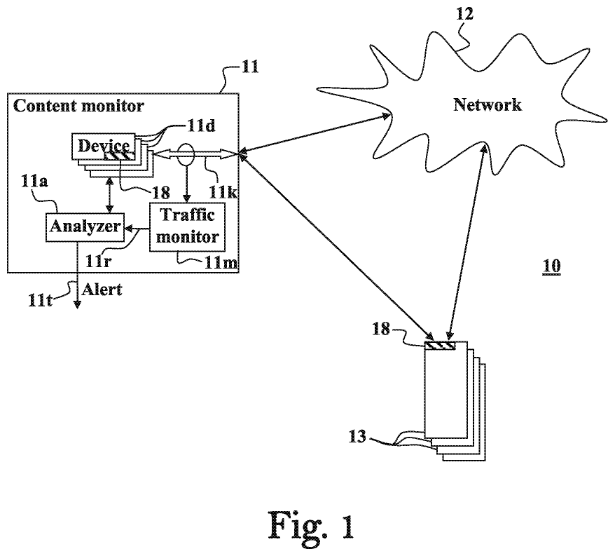

FIG. 1 is a functional block diagram of a system 10 usable for monitoring electronic content 18 accessible by one or more user devices 11d over a data network 12. The user devices 11d can be any type of computerized device (e.g., a smart phone or TV, a tablet, a personal computer, a laptop, a PDA, a media player) capable of communicating data with one or more computers 13 (e.g., data servers) via a communication link 11k configured for data exchange with and through the data network 12. The data network 12 may comprise cellular networks, public switched telephone networks (PSTN), local area networks (LAN/intranet), wide area networks (WAN), personal area networks (PAN or WPAN), the Internet, or any combination thereof. The user devices 11d are capable of accessing and interacting with electronic/digital content 18 maintained in the computerized devices 13, comprising, but not limited to video and/or audio files, webpages, games and/or other computer programs, advertisements, presentations, and suchlike.

The system 10 comprises a content monitor 11 utilizing a traffic monitoring unit 11m and an analyzer module 11a for tracking behavior of the electronic content 18 being accessed by the end user devices 11d. The traffic monitor 11m is configured and operable to monitor incoming and outgoing traffic data exchanged over the data communication link 11k of each end user device 11d, and generate traffic data 11r indicative thereof. The analyzer module 11a is configured to process and analyze the traffic data 11r from the traffic monitor 11m, and generate alerts/reports 11t whenever it determines that data exchange associated with electronic content 18 from one of the computerized devices does not comply with a certain criteria/policy.

The end user devices 11d may download digital content 18 from the computerized devices 13 via the data network 12 and carry out various actions therewith, such as, present/play the downloaded digital content and/or execute software code contained therein, all of which is generally referred to herein as interacting. For example, the downloaded content 18 may be presented in a browser or a presentation viewer, played by a media player, or executed by a processor (not shown) of an end user device 11d. The interaction of the user device 11d with the digital content 18 by the end user device 11d may cause data exchange over the communication link 11k between the end user device 111d and the computerized device 13 from which it was downloaded, or any other 30 computerized device 13 connected to the network 12.

The analyzer module 11a is configured and operable to identify interactions carried out between the downloaded electronic content 18 and the end user devices 11d, and generate interaction data indicative thereof. The interaction data generated by the analyzer module 11a and the traffic data generated by the traffic monitor 11m are processed by the analyzer module 11a to determine compliance thereof with the certain criteria/policy of the system. Thus, the analyzer module 11a can be adapted to identify in the traffic data 11r outgoing traffic data generated by the user device 11d in response to interaction with the digital content 18, and incoming traffic data requested by the user device 11d in response to the interaction with the digital content 18.

For example, and without being limiting, the analyzer module 11a can be configured to determine if data transmitted via the communication link 11k by an end user device 11d in response to its interaction with downloaded digital content 18 is offensive/violate users' privacy (e.g., by conveying sensitive/personal information about the user and/or the user's device 11d), and/or generate invalid traffic, such as false reports of events that according to the interaction data did not actually occur/take place in the user device 11d. The analyzer is configured to issue a respective alert/report 11t whenever such offensive and/or invalid traffic is identified.

Likewise, the analyzer module 11a can be configured to determine if data received via the communication link 11k by an end user device 11d in response to its interaction with downloaded digital content 18 is within the context of the interaction with the content 18, if it serves any valid purpose of the digital content 18, and/or if it is originated from a legitimate computerized device 13 associated with downloaded digital content 18. If it is determined that the incoming data traffic is not associated with the accessed digital content, not serving any purpose of the content, and/or not originated from a legitimate source, the analyzer will issue a corresponding alert/report 11t, that based on specific circumstances may be indicative of invalid traffic caused by the digital content 18.

In some possible embodiments, the analyzer module 11a is configured to identify in the outgoing traffic data 11r from the traffic monitor 11m the presence of a click-through event report, and the absence of a corresponding click-event in the interaction data, and accordingly determine the presence of a fake click-through event in the outgoing traffic data and issue a respective alert/report 11t. The analyzer module 11m can be also configured to identify presence of an install report in the outgoing traffic data from the traffic monitor 11m, and the absence of a corresponding install event in the interaction data, and accordingly determine presence of a fake install report in the outgoing traffic data and issue a respective alert/report 11t.

Optionally, and in some embodiments preferably, the analyzer module 11a is configured to cause/initiate an interaction between an end user device 11d and one or more of the computerized devices 13, generate respective interaction data indicative of the interaction, and process the respective traffic and interaction data to determine compliance thereof with the criteria/policy of the system. For example, and without being limiting, the analyzer module 11a can cause an application (e.g., web browser, played game, or media player) operating in a user device 11d to access digital content 18 (e.g., advertisement) maintained in one or more computerized devices 13, and examine the compliance of traffic generated by the user device 11d due to the interaction with the accessed content 18 with the criteria/policy of the system.

For this purpose, in some embodiments, the analyzer module 11a is adapted to set certain attributes/definitions of one or more end user devices 11d for causing software applications operated by them to access certain types of digital contents provided by one or more computerized devices 13. For example, and without being limiting, the analyzer module 11a can associate one or more end user devices 11d with certain geographical and/or genderial properties determined for causing software applications running in the user devices to download digital content of a certain type or category (e.g., a certain type, or a specific advertisement).

In some possible embodiments at least one of the computerized devices 13 is an advertisement server. Accordingly, the digital content 18 accessed by the user's devices 11d can be, or can comprise, advertisements. Optionally, and in some embodiments preferably, the end user devices 11d are virtual software instance clients (e.g., employing Oracle VM VirtualBox) maintained in a virtualization environment. In this case, the content monitor 11 is configured and operable to operate a plurality of virtual clients implementing the user devise 11d in a virtualization environment, and cause them to access and interact with the digital content 18 to be monitored by the system.

For digital content comprising advertisements, the analyzer can be configured to identify each advertisement included in the accessed content 18, or advertisements conveyed to the user device 11d over the communication link 11k while interacting with digital content 18, and determine if the presentation of the advertisements, and their interaction with the user device 11d comply with the system's criteria/policy.

The content monitor 11 can be configured to repeatedly challenge the digital content 18 accessed by the virtual clients to inspect their responsive behavior. For example, the analyzer module 11a can be configured to generate certain events (e.g., click-through, mouse hover, or suchlike events) for causing redirection to advertisers' sites and/or to cause the income of additional advertisements or other digital content via the communication link 11k. The analyzer module 11a then process and analyze the traffic data generated in response to the redirection and/or the income of new advertisements to determine if it complies with criteria/policy of the system. If it is determined that the generated traffic data is invalid (e.g., the virtual client is redirected to the wrong advertiser site, and/or the incoming advertisements belongs to the wrong advertiser and/or publisher), and/or that interaction data generated in response contains

faked events, the analyzer issues a respective alert/report 11t to report the invalid actions the generated event caused.

The content monitor 11 can be thus configured to audit advertisers' affidavits and verify that the advertisements accessed by the user devices 11d are presented to the end users, and interact with their devices, according to contracts/agreements between the advertisers and the publishers of accessed advertisements. Accordingly, in some embodiments the reports/alerts 11t are generated for indicating invalid interactions and/or communication traffics caused by the monitored advertisements, and/or improper presentation thereof in the end user device 11d.

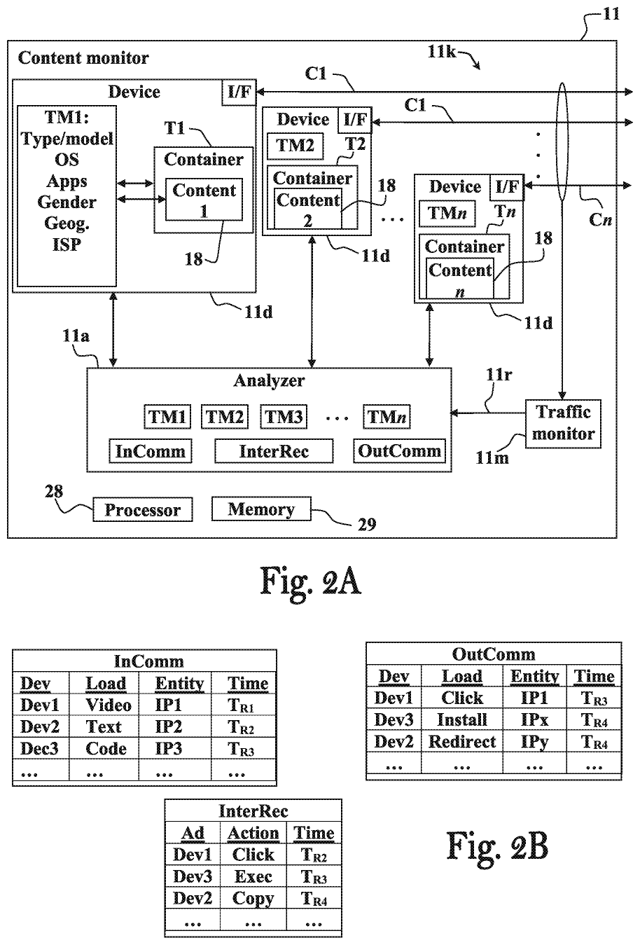

FIG. 2A is a block diagram showing an implementation of the content monitor 11, according to some possible embodiments. The content monitor 11 comprises one or more processors 28 and memories 29 configured and operable to store and execute software instructions carrying out operations of the analyzer module 11a and the end user devices 11d. The analyzer module 11a comprises a plurality of test modules TM1, TM2, TM3, . . . , TMn, each configured to define properties of one of the end user devices 11d, such as, but not limited to, the type and/or model of device (e.g., cellular phone, tablet, laptop, and suchlike), the OS used in its operation, ISP used by the device, software application executed by the device, and/or gender and/or age and/or preferences and/or fields of interest of the user of the device.

Each end user device 11d is configured and operable to access at least one digital content via respective communication interface I/F and communication link C1, C2, . . . , Cn thereof. The digital content 18 accessed by each user device 11d can be incorporated inside a respective carrier medium/container T1, T2, . . . , Tn. The carrier medium/container T1, T2, . . . , Tn, of the accessed content can be a website, a software application used to display/play the digital content 18, or suchlike. The analyzer module 11a can be configured to further monitor the carrier medium/container T1, T2, . . . , Tn, of the content 18. The analyzer module 11a is thus configured to monitor interactions between the user device 11d and the container, any traffic data generated by the container, and determine inconsistencies therebetween and/or compliance with the predefined criteria/policy, as described hereinabove and hereinbelow. The analyzer module 11a can be further configured to cause interactions/events between the user device 11d and the container and check the consistency/compliance with the predefined criteria/policy of any traffic data generated in response to the caused interactions/events.

Optionally, and in some embodiments preferably, the test modules TMi (where 1≤i≤n is a positive integer) are implemented by scripts. Thus, in embodiments wherein the user devices 11d are implemented by a plurality of virtual machine instances, each test module TMi can be configured to activate a virtual machine and set it to virtualize a certain type of user device 11d, running certain software applications capable of accessing the digital content to be monitored, using a certain ISP, having a certain geographical location, and associated with certain properties of a user of the device 11d.

The analyzer module 11a can be configured to analyze all incoming and outgoing communication for identifying all network entities i.e., by Internet Protocol (IP) address association, to which outgoing network traffic been transmitted and from which incoming network traffic been received. For this purpose the analyzer module 11a comprises in some embodiments an incoming traffic monitoring module InComm configured and operable to monitor all incoming network traffic and associate it with content accessed by one or more user devices 11d, an outgoing traffic monitoring module OutComm configured and operable to monitor all outgoing network traffic and associate it with content accessed by one or more user devices 11d, and an interactions recorder module InterRec configured and operable to record all interactions occurring between the accessed content and the user devices 11d.

This way the analyzer module 11a can verify that only legitimate network entities, such as publishers and/or vendors associated with the accessed content/advertisement, are participating in the network communication. Whenever it is determined that network traffic is received from, or transmitted to, unrecognized network entities not associated with the content accessed by the user device 11d, the analyzer module 11a generates a corresponding report/alert to indicate possible noncompliance with system policy.

The present disclosure also provides techniques, and systems and methods implementing them, for monitoring network communication between the user's device and the publisher's site, between the device and the digital content provider or between any other related third party such as affiliate networks serving as middle-men between the digital content provider and the publisher.

FIG. 2B demonstrates operation of the InComm, OutComm and InterRec, modules in monitoring the communication traffic. In this specific and non-limiting example the InComm module monitored in the incoming network traffic the following communications: during time range TR1 user device Dev1 received a video clip from a network entity IP1 associated with the video content (18) accessed by Dev1, during time range TR2 user device Dev2 received some text from a network entity IP2 associated with the text content accessed by Dev2, and during time range TR3 user device Dev3 received executable code from network entity IP3 associated with content accessed by Dev3.

The InterRec module recorded during time range TR2 a click event carried out in device Dev1, during time range TR3 code execution carried out in user device Dev3, and during time range TR4 a text copy event carried out in user device Dev2. The OutComm module monitored in the outgoing network traffic the following communications: during time range TR3 the user device Dev1 reported a click event to the network entity IP1, during time range TR4 the user device Dev3 reported an install event to a network entity IPx and the user device Dev2 reported a copy event a network entity IPy.

The click event reported from device Dev1 to the network address IP1 associated with the video content accessed by Dev1 occurred in a time range TR2 after receipt of the video clip in Dev1, and the analyzer module 11a can thus determine that the reported click event is legitimate and occurred responsive to the presentation of the video. On the other hand, the install report from Dev3 to the unrecognized network entity Ipx, not associated with the code executed by Dev3, is identified by the analyzer module 11a as illegitimate and requires issuing a report/alert. The redirect report from Dev2 to unrecognized network entity IPy after the copy event occurred therein, can be also identified by the analyzer module 11a as illegitimate and requires issuing a report/alert.

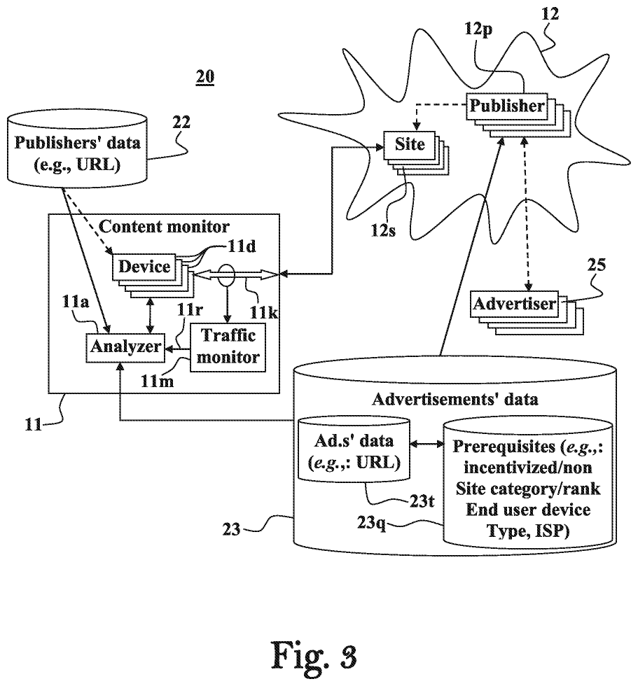

FIG. 3 is a block diagram of an advertisement monitoring system 20 according to some possible embodiments. The advertisement monitoring system 20 comprises the content monitor 11 configured and operable to access a plurality of websites 12s via the data network 12, a publisher's data repository 22 storing location data of publishers of advertisements, and an advertisements' repository storing property data about advertisements to be monitored by the content monitor 11. The websites 12s are configured to receive and present/provide access to advertisement data received from one or more publishers 12p, which are typically sponsored by one or more advertisers 25 interested that their advertisements be accessed and followed on by the ends user devices 11d.

In some embodiments the content monitor 11 is configured to receive from the publisher's data repository 22 locations and/or applications information for accessing by the user devices 11d the publisher's websites 12s in which the advertisements are being presented. In some embodiments the analyzer 11a and/or the user devices 11d are configured to receive from the publisher's data repository 22 network addresses (e.g., IP addresses and/or uniform resource locators—URL) of the publisher's sites 12s. In some embodiments the analyzer module 11a is configured to receive from the publisher's data repository 22 a plurality of network addresses and/or data indicative of executable applications adapted to interact with advertisements, and instruct each user device 11d to use the network addresses and/or the executable application to access a certain publisher site 12s for monitoring advertisements presented by it.

The advertisements' data repository 23 comprises in some embodiments a storage of advertisements' locators (e.g., URLs) 23t, and a storage of advertisements' prerequisites data 23q for maintaining a plurality records of property data of advertisements of the advertisers 25. Optionally, and in some embodiments preferably, for each advertisement locator record maintained in the storage 23t there is a respective properties record in the prerequisites storage 23q for maintaining properties of the respective advertisement. Each properties data record in the prerequisites storage 23q can hold descriptors of the respective advertisement indicative of at least one presentation configuration of advertisement (e.g., location and/or dimensions/size of the presented advertisement within a window). The properties data record can comprise an indication of whether the advertisement is incentivized, information about the types/categories of publishers' websites to be used for presenting the advertisement and/or ranks/weights associated with the publishers' sites and indicative of the publishers' sites of greater priority for presenting the advertisement. In addition, the properties data record can also include data indicative of the types of end user devices that the advertisement is aimed for (e.g., smartphones), and/or data indicative of internet service providers expected to be used by the publishers' sites presenting the respective advertisement.

The analyzer module 11a can be configured in some embodiments to fetch from the advertisements' data repository 23 data record of the advertisement's locator from the locators data storage 23t, and/or a data record of the advertisement's prerequisites from the prerequisites storage 23q. The analyzer module 11a can further fetch from the publishers' data repository 22 locators of the publishers' sites 12s used to present each of the advertisements. The analyzer module 11a can then instruct one or more (or all of) user devices 11d to access a specific publisher site in which a certain advertisement is expected to be presented, and then process and analyze the respective traffic and interaction data to check for each user device 11d if the expected advertisement is indeed presented in the respective publisher site being examined by it, and if the presentation of the advertisement and/or its interaction with the user device 11d complies the respective prerequisites and/or the criteria/policy.

The analyzer module 11a is configured in some embodiments to instruct one or more end user devices 11d to run certain applications (e.g., advertisement sponsored games) configured to receive advertisement data from the publishers' sites and present the advertisements. The analyzer module can then verify that certain advertisements aimed to be presented by the certain running applications are indeed accessed and presented by these applications. For this purpose the analyzer module can also associate each end user device 11d with a particular device type (e.g., a mobile telephone, a tablet, a personal computer, a laptop, a PDA, a media player, and smart TV), operating system (OS e.g., Android, IOS), and/or certain geographical and/or genderial properties, for causing the publishers sites to provide it with certain advertisement(s).

The analyzer module 11a can be configured to check the compliance of the advertisements accessed by each user device 11d with the specific device type, operating system, and/or geographical/genderial properties it was associated with. Additionally, the analyzer module 11a can associate the end user devices 11d with different ISPs, for determining statistics of provision of certain advertisements to the different ISPs the end user devices 11d are associated with. Optionally, and in some embodiments preferably, the analyzer module verifies the identity of the publishing site 12s, and/or examines the loading times of the advertisement from the publishing sites 12s and/or the location of the advertisement on the display generated by the publishing site 12s, and networks associated with the publisher and/or the advertiser 25.

The analyzer module 11a can thus use a customizable analysis engine (e.g., script based engine) configurable to process and analyze the publishing sites 12s to determine the validity of the advertisement presented by them. In some embodiments the analyzer module 11a is configured to utilize publisher identification data embedded in the monitored advertisement to identify the publisher 12p of the advertisement at the publishing sites 12s presenting it to the users. This way, the publishers 12p can be identified whenever network communication between the end user device 11d and the publisher 12p is indirect via one or more network affiliates.

Functions of the systems described hereinabove may be controlled through instructions executed by a computer-based control system. A control system suitable for use with the embodiments described hereinabove may include, for example, one or more processors connected to a communication bus, one or more volatile memories (e.g., random access memory—RAM) or non-volatile memories (e.g., Flash memory). A secondary memory (e.g., a hard disk drive, a removable storage drive, and/or removable memory chip such as an EPROM, PROM or Flash memory) may be used for storing data, computer programs or other instructions, to be loaded into the computer system.

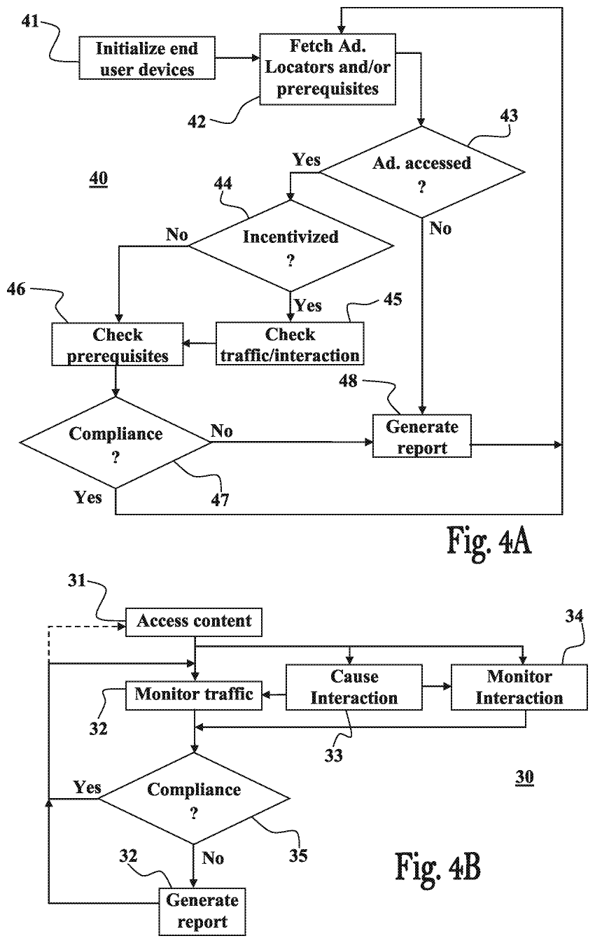

FIG. 4A is a flowchart illustrating a process 40 of monitoring advertisements according to some possible embodiment. The process 40 starts in the initialization step 41, in which the user devices/virtual clients 11d are configured and activated. The initialization step 41 can include associating one or more of the user devices 11d with certain device types or models, ISPs, geographical and/or genderial properties, operating system, and/or instructing one or more of the user device 11d to run certain programs for accessing certain advertisements. Next, in step 42, the advertisements' locators are fetched (e.g., form the publisher's data repository 22), and/or their prerequisites (e.g., advertisements' data repository 23).

Step 43 checks whether the actual advertisement to be monitored using the fetched locator and/or the executable application, and/or the device type/model, OS, and/or geographic/genderial, association, been accessed by each of the user devices. If it determined that the actual advertisement to be monitored was not accessed, then a respective report/alert is generated in step 48, and the process returns to step 42 in another attempt to access the same actual advertisement to be monitored, or in attempt to access another advertisement. If it is determined in step 43 that the actual advertisement to be monitored has been accessed, certain tests are carried out to check the compliance of the advertisement with the criteria/policy required by the system.

The compliance tests can be selectively carried out based on whether the advertisement is incentivized or not. For example, the analyzer module 11a can be configured to determine which test should be carried out based on the record of the advertisement's prerequisites from the storage 23q. Accordingly, if it is determined in step 44 that the accessed advertisement is not incentivized, the process proceeds in step 46 with checking compliance of the other prerequisites indicated in the record from the storage 23q (e.g., compliance of the publisher site, and/or its ISP, and/or its rank/weight, compliance of the type/model and/or OS and/or geographic/genderial properties of the end user device). In case of an incentivized advertisements, the validity of data traffic and/or generated events is also checked in step 45.

In step 47 it is checked if the prerequisites tests results obtained in step 46, and/or the traffic/events validations results obtained in step 45, comply with the criteria/policy required by the system. If non-compliance is determined in step 47, then a corresponding report/alert is generated in step 48, and the process returns to step 42 for monitoring another advertisement. In this specific and non-limiting example, if step 47 determine that there is compliance of the monitored advertisement with the systems criteria/policy the process returns to step 42 for monitoring another advertisement without generating any report/alert, since everything appear to be in order, but in certain embodiments the process 40 may be configured to also generate a report indicating the compliance of the monitored advertisement.

FIG. 4B is a block diagram illustrating a process 30 for monitoring a content accessed by the user devices 11d of the system. After the monitored content is accessed by a user device in step 31 various steps can be carried out in several possible orders. Step 34 can be used to monitor interactions between the accessed content and the user device, and generate respective interaction data indicative thereof, after the content is accessed in step 31, or after the analyzer cause one or more such interactions to take place in step 33. Additionally or alternatively, step 32 can be used to monitor communication traffic generated in response to accessing the monitored content and/or in response to interactions between the accessed content and the user device, and to generate respective traffic data indicative thereof, after the content is accessed in step 31, or after the analyzer cause one or more such interactions to take place in step 33.

In step 35 the compliance of the generated traffic and/or interaction data with the system's criteria/policy is checked. If non-compliance is determined in step 35, then a corresponding report/alert is generated in step 32. In case compliance is determined in step 35, or after a report/alert is generated in step 32, the process returns to any one, or more, of steps 32, 33 and/or 34, to conduct further tests on the monitored content. Alternatively, if there is no need to conduct further tests, the process can return to step 31 for accessing and monitoring another digital content.

Embodiments of the present application are applicable for monitoring the publishing of digital content that is accessible by users' devices via a variety of client manifestations such as executables, web browser clients, email clients etc. The purpose of this monitoring being to identify all the stakeholders involved in serving the digital content, and to audit all interactions between the user's device and any of these stakeholders, identifying whether they were or were not a result of a specific user action on the device. Once established, this information can be used to check compliance of the various stakeholders with any business agreements between them or any relevant regulations, and to verify that communication indicating a user action (e.g., clicking on content) takes place only in direct response to such an action performed by the user on the user's device and represents the action accurately and as required by the communication protocols between the stakeholders.

It should also be understood that throughout this disclosure, where a process or method is shown or described, the steps of the method may be performed in any order or simultaneously, unless it is clear from the context that one step depends on another being performed first. The processes described above may be realized as computer executable code created using a structured programming language (e.g., C), an object oriented programming language such as C++, or any other high-level or low-level programming language (including assembly languages, hardware description languages, and database programming languages and technologies) that may be stored, compiled or interpreted to run on any suitable storage (transitory or non-transitory) memory medium (e.g., magnetic, such as diskette, tape or fixed disk, or optical, such as a CD-ROM or DVD). Additionally, the software can be supplied via the Internet or some type of private data network. Optionally, processing is distributed across a number of computerized devices, which may be functionally integrated into a dedicated standalone processing system. All such permutations and combinations are intended to fall within the scope of the present disclosure.

Those of skill in the art would appreciate that items such as the various illustrative blocks, units, modules, elements, components, methods, operations, steps, and algorithms described herein may be implemented as entirely hardware embodiments, entirely computer software embodiments (including firmware, resident software, micro-code, etc.), or a combination of hardware and computer software, that may all generally be referred to herein as a “circuit,” “module” or “system.” Furthermore, aspects of the present invention may take the form of a computer program product embodied in one or more computer readable medium(s) having computer readable program code embodied thereon.

For example, computer programs (e.g., computer control logic) may be loaded from the secondary memory into a main memory for execution by one or more processors 15 of the control system. Alternatively or additionally, computer programs may be received via a communication interface. Such computer programs, when executed, enable the computer system to perform certain features of the present invention as discussed herein. In particular, the computer programs, when executed, enable a control processor to perform and/or cause the performance of features of the present invention. Accordingly, such computer programs may implement controllers of the computer system.

In embodiments where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein. Embodiments of the invention can be implemented primarily in hardware using, for example, hardware components such as application specific integrated circuits (ASICs) or field-programmable gated arrays (FPGAs).

As described hereinabove and shown in the associated figures, the present invention provides schemes for monitoring electronic/digital content such as, but not limited to, advertisements. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A system for monitoring electronic content, said system comprises:
an analyzer module adapted for activating an at least one interaction between an end user device and one or more computerized devices, wherein said at least one interaction causing an exchange of network data traffic between said end user device and said one or more computerized devices over a data communication link; and
a communication monitor adapted for monitoring said network data traffic;
wherein said analyzer module is further adapted for processing said network data traffic and for determining a compliance or incompliance of said network data traffic with a certain criteria.

2. The system of claim 1, wherein said activating said at least one interaction comprises activating an interaction data; wherein said analyzer module is further adapted to:
identifying presence of data item in said network data traffic and absence of a corresponding event in said interaction data to thereby identify said incompliance; or
identifying presence of event in said interaction data and absence of corresponding data item in said network data traffic to thereby identify said incompliance.

3. The system of claim 2, wherein said event comprises one member of a group consisting of a click event, a mouse event, a hover event, scrolling, and an interaction with electronic content presented in said end user device.

4. The system of claim 2, wherein said data item comprises, a network message or a plurality of network message or a combination of a plurality of network messages.

5. The system of claim 2, wherein said data item comprises electronic content, wherein said electronic content comprises one member of a group consisting of an advisement, a report and an ISP (internet service provider).

6. The system of claim 4, wherein said network message is an HTTP message.

7. The system of claim 1, wherein said analyzer module is further adapted for processing said network data traffic and identify presence or absence of one or more data items therein associated with said interaction, to determine said compliance with said certain criteria based thereon.

8. The system of claim 1, wherein said network data traffic comprises a publication of an at least one advertisement by at least one publisher in one or more publishing sites and wherein said analyzer is configured to determine whether said publication comply with said certain criteria.

9. The system of claim 1 wherein said end user device is of a certain device type, and wherein said analyzer module is adapted to determine whether provision of said advertisement to said device type complies with said certain criteria.

10. The system of claim 1, wherein said end user device is at least one of an actual end user device and virtual machine emulation associated with a particular device model and operating system.

11. The system of claim 1, wherein said certain criteria being indicative of respective publication prerequisites of an advertisements.

12. The system of claim 1, wherein said criteria comprises one member of a group consisting of configuration of content to be presented at said end user device, type of audience of said network data traffic, type of device or operating system said network data traffic is aimed for, fake click-through and fake reports.

13. The system of claim 1 wherein said interaction data being generated by said end user device from a script.

14. A method for monitoring electronic content, said method comprises:
activating an at least one interaction between an end user device and one or more computerized devices, wherein said at least one interaction causing an exchange of network data traffic between said end user device and said one or more computerized devices over a data communication link;
monitoring said network data traffic; and
processing said network data traffic and determining a compliance or incompliance of said network data traffic with a certain criteria.

15. The method of claim 14, wherein said activating said at least one interaction comprises activating an interaction data; and wherein said method further comprises:
identifying presence of data item in said network data traffic and absence of a corresponding event in said interaction data to thereby identify said incompliance; or
identifying presence of event in said interaction data and absence of corresponding data item in said network data traffic to thereby identify said incompliance.

16. The method of claim 15, wherein said event comprises one member of a group consisting of a click event, a mouse event, a hover event, scrolling, and an interaction with electronic content presented in said end user device,

17. The method of claim 15, wherein said data item comprises a network message or a plurality of network message or a combination of a plurality of network messages.

18. The method of claim 14, wherein said interaction data being generated by said end user device from a script.

19. The method of claim 14, wherein said criteria comprises one member of a group consisting of configuration of content to be presented at said end user device, type of audience of said network data traffic, type of device or operating system said network data traffic is aimed for, fake click-through and fake reports.

20. A non-transitory computer-readable storage medium storing instructions, the instructions cause the processor to:
activating an at least one interaction between an end user device and one or more computerized devices, wherein said at least one interaction causing an exchange of network data traffic between said end user device and said one or more computerized devices over a data communication link;
monitoring said network data traffic; and
processing said network data traffic and for determining a compliance or incompliance of said network data traffic with a certain criteria.
